(19) United States
(12) Patent Application Publication
(10) Pub. No.: US 2003/0154139 A1
(43) Pub. Date: Aug. 14, 2003

(54) Secure m-commerce transactions through legacy POS systems

(76) Inventor: Kevin K. M. Woo, Surrey (CA)

Correspondence Address: OGILVY RENAULT, 1981 MCGILL COLLEGE AVENUE, SUITE 1600, MONTREAL, QC, H3A2Y3, CA

(21) Appl. No.: 10/334,149

(22) Filed: Dec. 31, 2002

Related U.S. Application Data
(60) Provisional application No. 60/343,228, filed on Dec. 31, 2001.

(51) Int. Cl. G06F 17/60

(52) U.S. Cl. 705/26

(57) ABSTRACT

A method for conducting an electronic commerce transaction between a customer and a merchant, the transaction using customer information stored in a customer device and transaction information both stored and entered into a merchant device, the method including the steps of: providing an entity for collecting the customer and transaction information from the customer and merchant devices and for generating a transaction identification number for the transaction, wherein the transaction identification number includes a unique personal account number (PAN) for identifying the entity; sending the transaction identification number from the entity to the customer and/or customer device to commence the transaction by the customer providing the transaction identification number to a point-of-sale device; detecting the transaction identification number at an acquirer device, being in communication with the point-of-sale terminal, to identify the entity; requesting the customer and transaction information from the entity by the acquirer device; and, sending the customer and transaction information from the entity to the acquirer device to determine a result for the transaction.

This application claims the benefit of U.S. Provisional Patent Application No. 60/343,228, filed Dec. 31, 2001, and incorporated herein by reference.

The invention relates to the field of mobile commerce (“m-commerce”), and more specifically to m-commerce transactions conducted through the existing point-of-sale (“POS”) infrastructure.

### BACKGROUND OF THE INVENTION

M-commerce is the buying and selling of goods and services through wireless handheld devices such as cellular telephones and personal digital assistants (“PDAs”). Often referred to as next-generation e-commerce, m-commerce enables users to access the Internet without having to find a place to “plug in”. As content delivery over wireless devices becomes faster, more secure, and scalable, there is wide speculation that m-commerce will surpass wireline e-commerce as the method of choice for e-commerce transactions.

M-commerce may be used for transactions relating to financial services (e.g. mobile banking where customers use their handheld devices to access their accounts and pay their bills), brokerage services (e.g. stock quotes can be displayed and trading conducted from the same handheld device), telecommunications (e.g. service changes, bill payment, and account reviews can all be conducted from the same handheld device), information services (e.g. the delivery of financial news, sports results, and traffic updates to a single mobile device), and general retail where consumers are given the ability to place and pay for orders for goods and services on-the-fly

In order to exploit the m-commerce market potential, cellular telephone handset manufacturers are working with cellular telephone carriers to develop improved smart phones and communication protocols. Using Bluetooth technology, for example, smart phones offer fax, e-mail, and telephone capabilities all in one unit, thus paving the way for m-commerce to be accepted by increasingly mobile users.

One shortcoming of current m-commerce systems is that consumers find the provided security and user interface features cumbersome to use. For example, it can be inconvenient for a consumer to enter a credit card number through the keypad of a cellular telephone.

A need therefore exists for improved security and ease-of-use in m-commerce systems. Consequently, it is an object of the present invention to obviate or mitigate at least some of the above mentioned disadvantages.

### SUMMARY OF THE INVENTION

According to one aspect of the invention, there is provided a method for conducting an electronic commerce transaction between a customer and a merchant, the transaction using customer information stored in a customer device and transaction information both stored and entered into a merchant device, the method including the steps of: providing an entity for collecting the customer and transaction information from the customer and merchant devices and for generating a transaction identification number for the transaction, wherein the transaction identification number includes a unique personal account number (“PAN”) for identifying the entity; sending the transaction identification number from the entity to the customer and/or customer device to commence the transaction by the customer providing the transaction identification number to a point-of-sale device; detecting the transaction identification number at an acquirer device, being in communication with the point-of-sale terminal, to identify the entity; requesting the customer and transaction information from the entity by the acquirer device; and, sending the customer and transaction information from the entity to the acquirer device to determine a result for the transaction.

Preferably: the method further includes the step of storing the customer and transaction information at the entity; the method further includes the step of linking the transaction identification number to the customer and transaction information at the entity; the method farther includes the step of authenticating the customer by the entity comparing a user ID and a user password for the customer entered by the customer and transmitted to the entity during the transaction to a user ID and a user password for the customer previously stored at the entity; the method further includes the step of authenticating the customer device by the entity comparing device specific information for the customer device transmitted to the entity during the transaction to device specific information for the customer device previously stored at the entity; the device specific information includes an IP address; at least some of the customer information is entered into the entity prior to the transaction; the transaction identification number is generated by the entity prior to the transaction; at least some of the transaction information is entered into the merchant device prior to or during the transaction; the transaction identification number is generated by the entity during the transaction in real-time; the transaction is a mobile commerce (m-commerce) transaction; the customer device is a wireless device; the wireless device includes a cellular telephone and a personal digital assistant; the point-of-sale device is a point-of-sale (POS) terminal; the entity, the merchant device, and the acquirer device are servers connected to a network; the network includes a wireless network and the Internet; the transaction includes a credit card transaction and a debit card transaction; the transaction includes a card-present credit card transaction and a card-present debit card transaction; and, the transaction includes a card-not-present credit card transaction and a card-not-present debit card transaction.

Advantageously, the PAN range payment feature of the present invention can be applied to well-known m-commerce standards for making payments through traditional POS environments. In addition, the present invention may be used for card-less transactions.

### BRIEF DESCRIPTION OF THE DRAWINGS

Embodiments of the invention may best be understood by referring to the following description and accompanying drawings. In the description and drawings, like numerals refer to like structures and/or processes. In the drawings:

FIG. 1 is a schematic diagram illustrating a traditional POS system and payment method in accordance with the prior art;

FIG. 2 is a schematic diagram illustrating an m-commerce system and transaction method in accordance with an embodiment of the invention;

FIG. 3 is a schematic diagram illustrating a 3-D Secure and/or SecureCode standards based m-commerce payment system and method in accordance with the prior art; and,

FIG. 4 is a flow chart illustrating a general method for conducting an m-commerce transaction between a customer and a merchant in accordance with an embodiment of the invention.

### DETAILED DESCRIPTION OF THE PREFERRED EMBODIMENTS

In the following description, numerous specific details are set forth to provide a thorough understanding of the invention. However, it is understood that the invention may be practiced without these specific details. In other instances, well-known structures or and/or processes have not been described or shown in detail in order not to obscure the invention.

In general, the present invention improves security for m-commerce transactions by using personal account number (PAN) ranges and existing or legacy POS mechanisms. The invention may be used in conjunction with new m-commerce standards introduced by Visa International (i.e. 3-D Secure) (TM) and MasterCard (i.e. Secure Payment Architecture (“SPA”) or SecureCode) (TM). The 3-D Secure and SecureCode standards form the basis of Visa's Visa Authenticated Payment strategy. These standards have the following common elements:

1. Merchant generation of short-lived unique transaction information based on the transaction at hand;

2. Pre-validation of the user against a server-side consumer electronic wallet (“e-wallet”) server before the transaction is accepted and processed by the financial host. This pre-validation step involves the generation of a secure identifier for the transaction. The secure identifier may be a digital signature, a message authentication code (“MAC”), or a short-lived token; and,

3. Acquirer validation of the secure identifier before accepting and processing the transaction.

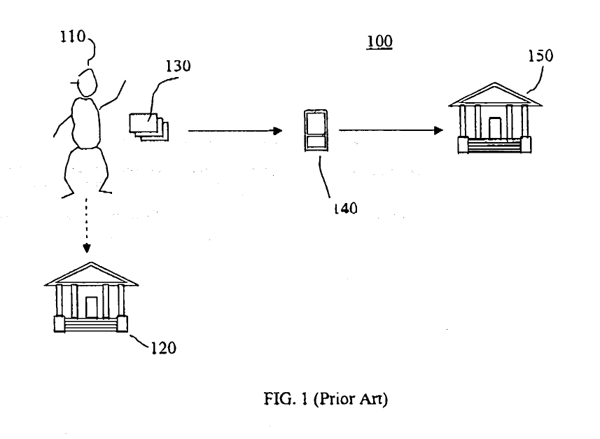

System. FIG. 1 is a schematic diagram illustrating a traditional POS system and payment method 100 in accordance with the prior art. A customer 110 has a relationship with an issuing financial institution or issuer 120. Credit cards 130 are issued from the issuer 120 on behalf of the customer or cardholder 110. The customer 110 uses these credit cards 130 with specific personal account number (PAN) ranges from Visa, MasterCard, AMEX, Diners, and others to affect a credit payment. The credit payment originates at the POS terminal 140 of a card acceptor and is routed directly to the acquiring financial institution or acquirer 150.

The cardholder or customer 110 is the party ultimately responsible for paying for the product of service purchased through the credit payment. The issuer 120 issues credit cards 130 to customers 110. The issuer 120 could be, for example, American Express, Visa, MasterCard, a bank, a department store, or an oil company. In general, the issuer 120 may be any organization that issues credit cards 130 and that is responsible for billing the customer 110. The card acceptor is any organization set up to accept credit cards 130 in payment for goods or services and may be, for example, a merchant. The acquirer 150 occupies a position between the card acceptor and card issuer 120. For example, when a cashier at a restaurant takes a customer's credit card 130 and runs it through a POS terminal 140, the information on the card is passed on to the acquirer 150, who decides whether or not to approve the purchase and then guarantees payment to the restaurant. Often, card issuers 120 are also acquirers 150.

With respect to the credit card 130, it typically conforms to standards established by the American National Standards Institute (“ANSI”) and the International Standards Organization (“ISO”). These standards dictate card shape, size, and numbering. As for card numbering, while department stores and oil companies and others tend to have proprietary systems, most major credit card issuers follow standards laid out by ANSI and/or ISO. Within those standards there is some variation. For example, Visa and MasterCard generally have 16-digit card numbers while American Express cards have 15 digits. In all cases, the first digits represent the credit card system. If a credit card number starts with a 4, it's generally a Visa card. If it begins with the numbers 51, 52, 53, 54, or 55, it's generally a MasterCard. American Express card numbers begin with either 34 or 37. On Visa cards, the second through sixth numbers designate the bank associated with the card. Numbers seven through fifteen represent the customer's PAN or PAN range. MasterCard numbers are similar. American Express cards have no bank numbers and digits five through eleven represent the account number. PANs are assigned according to rules set up by the ISO, which maintains a registry of all credit card numbers. On most credit cards, the final number is a check digit, which is used when for verifying the validity of the preceding number string. Check digits are determined by running the number string through a mathematical operation; the resulting number is then appended to the card number.

Security is an important issue in m-commerce. Typically, security is addressed through the use of two mandatory validation steps and one optional validation step. The mandatory steps are customer authentication and device authentication. To perform these steps the following information must be present: a user name, a user password, a device identifier, and, optionally, a device unlock code. The user name and user password authenticates the customer and the device identifier authenticates the device against a carrier's network. Typically, there is sufficient security within a carrier's network to authenticate a mobile device. For example, the cloning of digital phones is not widespread. Optionally, a device unlock code can be used to ensure that the customer is authorized to use the device. As will be described below, the optional validation step involves digitally signing the payment request sent from the mobile device to the merchant. A digital signature for the purchase request ensures that the customer intended to make the purchase.

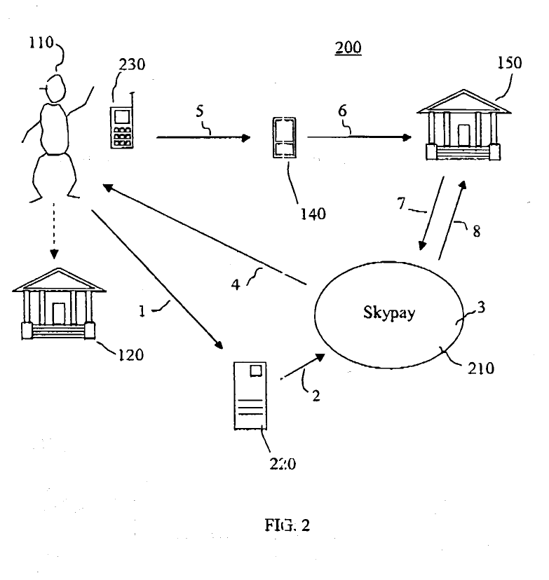

FIG. 2 is a schematic diagram illustrating an m-commerce system and transaction method 200 in accordance with an embodiment of the invention. The m-commerce system 200 includes an m-commerce infrastructure (e.g. “Skypay” (TM)) 210, a merchant 220, a wireless device 230 for the customer 110, a POS terminal 140, an acquirer 150, and an issuer 120. The m-commerce infrastructure 210, the merchant 220, the acquirer 150, and the issuer 150 may include servers. The wireless device 230 may include cellular telephones and PDAs. The m-commerce infrastructure 210, the merchant 220, the acquirer 150, the issuer 120, the wireless device 230, and the POS terminal 140 are in data communication via a network, which may include a wireless network.

The m-commerce infrastructure 210, the merchant 220, the acquirer 150, the issuer 120, the wireless device 230, and the POS terminal 140 may include input devices, central processing units or CPUs, memory, and displays. The input devices may include keyboards, mice, trackballs, or similar devices. The CPUs may include dedicated coprocessors and memory devices. The memory may include RAM, ROM, databases, or disk devices. And, the displays may include computer screens or terminal devices. The m-commerce system 200 has stored therein data representing sequences of instructions which when executed cause the method described herein to be performed. Of course, the m-commerce system 200 may contain additional software and hardware a description of which is not necessary for understanding the invention.

In the operation of this m-commerce system 200, a PAN range is generated by the m-commerce infrastructure 210 to affect a secure card-not-present payment through a traditional POS environment 110, 120, 140, 150. Note that the PAN range may be a transaction identification number that includes a generated PAN range rather than simply a PAN range. In his scenario, the customer 110, 230 initiates 1 a payment request to the merchant 220. The content of the payment request may include traditional payment information (e.g. payment amount, etc.) and, optionally, information identifying the specific goods or services rendered by the merchant 220. This payment request may be initiated by the wireless device 230, via the Internet, WAP, or through in-store kiosks. The payment request is then sent 2 by the merchant 220 to the m-commerce infrastructure 210. The payment request is temporarily stored 3 within the m-commerce infrastructure 210 and will be used to relate the payment request to a payment transaction originating from the POS terminal 140.

The customer 110 affects a payment through the traditional POS terminal 140 by providing a unique PAN range that has been generated and assigned 4 by the m-commerce infrastructure 210 for use in this manner. The unique PAN range may have been previously provided at the time of registration of the customer 110 with the m-commerce infrastructure 210. Alternatively, the unique PAN range may be provided 4 in real-time as part of an automated registration procedure. This unique PAN range may be relatively static and is assigned on a per customer basis. Alternatively, the PAN range can be generated on a per transaction basis. In both cases, the customer 110 makes a payment via a traditional POS terminal 140, no different than making a traditional credit card payment. However, instead of typing a valid credit card number, the unique PAN range is provided 5 by the customer 110. The unique PAN range may be communicated by the wireless device 230 to the POS terminal 140 via a number of means including infra-red (“IR”) communications, Bluetooth, 802.11b, etc. The payment request is then sent 6 to the acquirer 150 for processing.

At the acquirer 150, the unique PAN range is detected and instead of proceeding with traditional credit card processing, the payment transaction is routed 7 to the m-commerce infrastructure 210. In general, the unique PAN range is a number not usually assigned to regular credit card holders. The unique PAN range is detected by a detector (not shown). Typically, the detector is located before or at the acquirer 150 and has the ability to detect the unique PAN range (or BIN in the case of a credit card type transaction) and to route 7 this information to the m-commerce infrastructure 210. Since this is typically a normal function of the acquirer 150, simple configuration changes may be made to establish an appropriate routing table. Payment transaction details from the merchant 220 along with customer credential information are then used to create a traditional (legacy) payment request. The customer's actual credit card number may be looked-up during this process. This traditional or “converted” payment request is then sent 8 from the m-commerce infrastructure 220 to the acquirer 150 for processing. Note that the customer 110 has an account with the m-commerce infrastructure 210. Customer credential information (e.g. actual credit card number, etc.) is stored in the customer's e-wallet (i.e. account, etc.) during registration with the m-commerce infrastructure 210.

An advantage of the present invention is that the PAN range payment mechanism can be applied to well-known m-commerce standards for making payments through traditional POS environments. This PAN range concept can be applied to standards such as Visa's 3-D Secure and MasterCard's SecureCode.

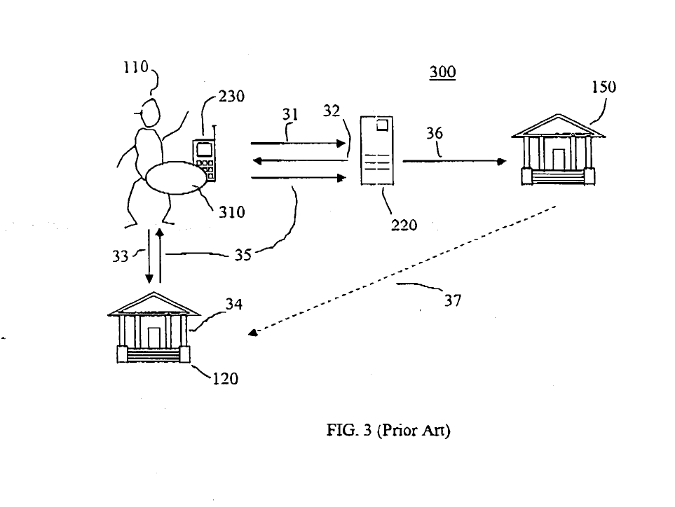

FIG. 3 is a schematic diagram illustrating a 3-D Secure and/or SecureCode standards based m-commerce payment system and method 300 in accordance with the prior art. As mentioned above, prior art m-commerce standards involve pre-validation of the customer before the customer is allowed to affect a payment request. The main difference between these standards lies in the information or data that is used for pre-validation. In FIG. 3, a customer 110 initiates 31 a payment request to the merchant 220. In response, the merchant server 220 initiates 32 communications with a payment application 310 that resides locally on the customer's device 230. Typically, this payment application 310 is provided by the issuer 120. In the case of MasterCard's SecureCode standard, the payment application is an applet which runs on the wireless device 230. In the case of Visa's 3-D Secure standard, the payment application 310 is an instance of the local web browser pointing to the issuer's website. In general, the payment application 310 is specially written and deals specifically with the pre-validation step. The payment application 310 forwards 33 the details of the payment transaction to the issuer 120. In turn, the issuer 120 generates 34 a short-lived identifier for the transaction. In the case of Visa's 3-D Secure standard, the identifier takes the form of a transaction identifier and a corresponding digital signature. In the case of Mastercard's SecureCode standard, the identifier takes the form of either a MAC or a unique token.

The identifier is routed 35 by the issuer 120 through the payment application 310 to the merchant 220. In the case of Visa, the merchant 220 is required to conform to the 3-D Secure specification and the identifiers (i.e. transaction identifier and digital signature) are sent as part of the 3-D Secure messaging scheme. In the case of MasterCard, the merchant 220 is not required to conform to any special SecureCode messaging. The merchant 220 can continue supporting the standard Internet payment mechanisms. The MAC or token is sent using the universal cardholder authentication field (“UCAF”). The UCAF is a hidden field on Internet payment entry screens and is sent as part of the message to an Internet Payment Gateway (“IPG”).

Next, the merchant 220 sends 36 the payment request along with the identifier to the acquirer 150. If the acquirer 150 has the ability to validate the digital signature, MAC, or token, the validation of the transaction will take place at the acquirer 150. However, if the acquirer 150 does not have this ability, the acquirer 150 will send 37 the identifier to the issuer 120 for validation. Once the payment transaction has been validated, the payment is then processed. Due to recent collaborative efforts between Visa and MasterCard, an alternative mechanism exists wherein the MasterCard MAC or token can be sent in place of the digital signature. The acquirer 150 has the ability to differentiate between a Visa 3-D Secure transaction and a MasterCard SecureCode transaction riding on top of the Visa 3-D Secure transport.

Advantageously, the PAN range aspect of the present invention can be applied in environments 300 that implement standards such as 3-D Secure and SecureCode. In addition, the present invention provides the ability to affect a secure m-commerce transaction through traditional POS environments 100. In these environments, standards such as 3-D Secure and SecureCode solve issues such as non-repudiation and reduced charge-backs to the merchant. A further advantage of the present invention is that merchants 220 do not need to be concerned with implementing a particular payment mechanism because the m-commerce infrastructure 210 handles the details of the various m-commerce standards.

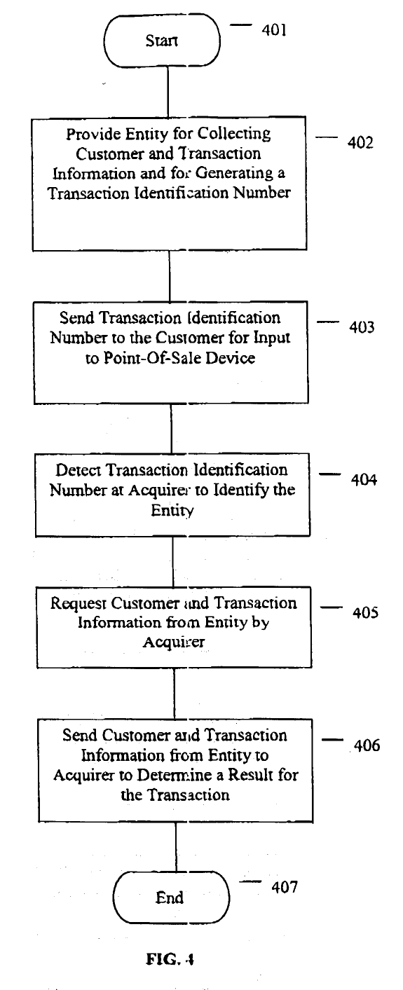

Method. FIG. 4 is a flow chart 400 illustrating a general method for conducting an m-commerce transaction between a customer and a merchant in accordance with an embodiment of the invention. The transaction uses customer information stored in a customer device and transaction information both stored and entered into a merchant device. At step 401, the method starts. At step 402, an entity is provided for collecting the customer and transaction information from the customer and merchant devices and for generating a transaction identification number for the transaction. The transaction identification number includes a unique personal account number (PAN) for identifying the entity. At step 403, the transaction identification number is sent from the entity to the customer and/or customer device to commence the transaction by the customer providing the transaction identification number to a point-of-sale (POS) device. Note that in the case of on-line transactions, the POS terminal 140 may be a virtual POS terminal or device. At step 404, the transaction identification number is detected at an acquirer device, being in communication with the point-of-sale terminal, to identify the entity. At step 405, the customer and transaction information is requested from the entity by the acquirer device. At step 406, the customer and transaction information is sent from the entity to the acquirer device to determine a result for the transaction. At step 407, the method ends.

Preferably: the method further includes the step of storing the customer and transaction information at the entity; the method further includes the step of linking the transaction identification number to the customer and transaction information at the entity; the method further includes the step of authenticating the customer by the entity comparing a user ID and a user password for the customer entered by the customer and transmitted to the entity during the transaction to a user ID and a user password for the customer previously stored at the entity; the method further includes the step of authenticating the customer device by the entity comparing device specific information for the customer device transmitted to the entity during the transaction to device specific information for the customer device previously stored at the entity; the device specific information includes an IP address; at least some of the customer information is entered into the entity prior to the transaction; the transaction identification number is generated by the entity prior to the transaction; at least some of the transaction information is entered into the merchant device prior to or during the transaction; the transaction identification number is generated by the entity during the transaction in real-time; the transaction is a mobile commerce (m-commerce) transaction; the customer device is a wireless device; the wireless device includes a cellular telephone and a personal digital assistant; the point-of-sale device is a point-of-sale (POS) terminal; the entity, the merchant device, and the acquirer device are servers connected to a network; the network includes a wireless network and the Internet; the transaction includes a credit card transaction and a debit card transaction; the transaction includes a card-present credit card transaction and a card-present debit card transaction; and, the transaction includes a card-not-present credit card transaction and a card-not-present debit card transaction.

Data Carrier Product. The sequences of instructions which when executed cause the method described herein to be performed by the m-commerce system of FIG. 2 can be contained in a data carrier product according to an embodiment of the invention. This computer software product can be loaded into and run by the m-commerce system of FIG. 2.

Computer Software Product. The sequences of instructions which when executed cause the method described herein to be performed by the m-commerce system of FIG. 2 can be contained in a computer software product according to an embodiment of the invention. This computer software product can be loaded into and run by the m-commerce system of FIG. 2.

Integrated Circuit Product. The sequences of instructions which when executed cause the method described herein to be performed by the m-commerce system of FIG. 2 can be contained in an integrated circuit product including a coprocessor or memory according to an embodiment of the invention. This integrated circuit product can be installed in the m-commerce system of FIG. 2.

Although preferred embodiments of the invention have been described herein, it will be understood by those skilled in the art that variations may be made thereto without departing from the spirit of the invention or the scope of the appended claims.

The embodiments of the invention in which an exclusive property or privilege is claimed are defined as follows:

1. A method for conducting an electronic commerce transaction between a customer and a merchant, said transaction using customer information stored in a customer device and transaction information stored in a merchant device, said method comprising the steps of:
providing an entity for collecting said customer and transaction information from said customer and merchant devices and for generating a transaction identification number for said transaction, wherein said transaction identification number includes a unique personal account number (PAN) for identifying said entity;
sending said transaction identification number from said entity to said customer or said customer device to commence said transaction by said customer providing said transaction identification number to a point-of-sale device;
detecting said transaction identification number at an acquirer device, being in communication with said point-of-sale device, to identify said entity;
requesting said customer and transaction information from said entity by said acquirer device; and,
sending said customer and transaction information from said entity to said acquirer device to determine a result for said transaction.

2. The method of claim 1 and further comprising the step of storing said customer and transaction information at said entity.

3. The method of claim 2 and further comprising the step of linking said transaction identification number to said customer and transaction information at said entity.

4. The method of claim 3 and further comprising the step of authenticating said customer by said entity comparing a user ID and a user password for said customer entered by said customer and transmitted to said entity during said transaction to a user ID and a user password for said customer previously stored at said entity.

5. The method of claim 4 and further comprising the step of authenticating said customer device by said entity comparing device specific information for said customer device transmitted to said entity during said transaction to device specific information for said customer device previously stored at said entity.

6. The method of claim 5 wherein said device specific information includes an IP address.

7. The method of claim 1 wherein at least some of said customer information is entered into said entity prior to said transaction.

8. The method of claim 1 wherein said transaction identification number is generated by said entity prior to said transaction.

9. The method of claim 1 wherein at least some of said transaction information is entered into said merchant device prior to or during said transaction.

10. The method of claim 1 wherein said transaction identification number is generated by said entity during said transaction in real-time.

11. The method of claim 1 wherein said transaction is a mobile commerce (m-commerce) transaction.

12. The method of claim 1 wherein said customer device is a wireless device.

13. The method of claim 12 wherein said wireless device includes a cellular telephone and a personal digital assistant.

14. The method of claim 1 wherein said point-of-sale device is a point-of-sale (POS) terminal.

15. The method of claim 1 wherein said entity, said merchant device, and said acquirer device are servers connected to a network.

16. The method of claim 15 wherein said network includes a wireless network and the Internet.

17. The method of claim 1 wherein said transaction includes a credit card transaction and a debit card transaction.

18. The method of claim 1 wherein said transaction includes a card-present credit card transaction and a card-present debit card transaction.

19. The method of claim 1 wherein said transaction includes a card-not-present credit card transaction and a card-not-present debit card transaction.
